(19) United States
(12) Patent Application Publication
(10) Pub. No.: US 2007/0126746 A1
(43) Pub. Date: Jun. 7, 2007

(54) MANAGING INFORMATION IN MOBILE COMMUNICATION TERMINAL

(75) Inventor: Byung Yul Lee, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG ELECTRONICS INC.

(21) Appl. No.: 11/563,314

(22) Filed: Nov. 27, 2006

(30) Foreign Application Priority Data
Dec. 1, 2005 (KR) 10-2005-0116342

(51) Int. Cl. G06T 1/60

(52) U.S. Cl. 345/530

(57) ABSTRACT

The present invention relates to managing information in a mobile communication terminal. Preferably, the present invention includes detecting whether a first memory is operationally connected to the mobile communication terminal, storing first attribute information related to data stored in the first memory in an internal memory of the mobile communication terminal with second attribute information stored in the internal memory, wherein the second attribute information is related to data stored in the internal memory, and arranging the first attribute information and the second attribute information in the internal memory in a sequence according to a specific reference.

### CROSS-REFERENCE TO RELATED APPLICATIONS

Pursuant to 35 U.S.C. § 119(a), this application claims the benefit of earlier filing date and right of priority to Korean Application No. 10-2005-0116342, filed on Dec. 17, 2005, the contents of which are hereby incorporated by reference herein in their entirety.

### FIELD OF THE INVENTION

The present invention relates to information management and more particularly, to managing information in a mobile communication terminal.

### BACKGROUND OF THE INVENTION

Recently, mobile communication terminals hindered by the limits of an embedded memory are manufactured with a structure capable of employing an additional external memory to overcome the constraints of the embedded memory. Moreover, digital cameras, personal digital assistants (PDAs), digital music players (e.g., MP3 players) and the like have adopted structures capable of employing an external memory as well.

Most external memories are card types. Notably, a card type memory is loaded into and unloaded from a terminal. However, when loading an external memory into a terminal according to a related art, a processor must directly access data of the external memory to manage the data stored in the external memory.

FIG. 1 is a diagram illustrating an arranged memory structure when inserting an external memory into a terminal according to a related art. Here, a plurality of media are arranged without metadata when loading (inserting) the external memory. Referring to FIG. 1, if an external memory, i.e., a memory card is loaded (inserted) while attributes (e.g., names) of media stored in an embedded memory are arranged, information related to the media stored in the memory card and information related to media stored in the embedded memory are displayed.

In this case, the information related to the media stored in the memory card is separated from the information related to the media stored in the embedded memory. Accordingly, the information (e.g., media names) related to the media stored in the memory card is arranged separately from the information (e.g., media names) of the media stored in the embedded memory. Furthermore, the media names are randomly arranged, as shown in FIG. 1.

In the related art, because there exist no metadata for the media stored in the memory card, the information related to the media stored in the memory card is arranged at a rear of the information related to the media stored in the embedded memory. Therefore, it is difficult to arrange the information related to the media stored in the memory card and the information related to the media stored in the embedded memory in a sequence according to one reference in order to combine all information together.

Furthermore, in the related art, a fixed memory is used for storing information, such as attribute information of media. However, a capacity of the fixed memory for supporting the storage of media is limited. Moreover, in the related art, because a processor needs to directly access a memory card, a time (latency) required for accessing media stored in the memory card (external memory) is increased.

### SUMMARY OF THE INVENTION

The present invention is directed to managing information in a mobile communication terminal that substantially obviates one or more problems due to limitations and disadvantages of the related art.

Advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for managing information in a mobile communication terminal comprises detecting whether a first memory is operationally connected to the mobile communication terminal, storing first attribute information related to data stored in the first memory in an internal memory of the mobile communication terminal with second attribute information stored in the internal memory, wherein the second attribute information is related to data stored in the internal memory, and arranging the first attribute information and the second attribute information in the internal memory in a sequence according to a specific reference. Preferably, the first memory is an external memory.

In one aspect of the invention, the method further comprises generating compatible first attribute information for the data stored in the first memory if the first attribute information does not exist in the first memory.

In another aspect of the invention, the method further comprises formatting the first attribute information to be compatible with the second attribute information if the first attribute information is not compatible with the second attribute information.

Preferably, the first attribute information and the second attribute information are stored and arranged in a specific area of the internal memory. Preferably, the specific area is a heap memory.

In a further aspect of the invention, the method further comprises displaying the first attribute information and second attribute information according to the arranged sequence.

In yet another aspect of the invention, the method further comprises designating at least one of the first attribute information in the internal memory for accessing the data in the first memory related to the at least one of the first attribute information, and accessing the data in the first memory related to the at least one of the first attribute information designated in the internal memory.

Preferably, the first and second attribute information respectively comprise at least one of a name of data, a type of data, a generation time of data, a size of data, a copyright proprietor of data, a generating device of data, a position and contents of data, media rights conditions of data, media use conditions of data, and media use history of data. Preferably, the first and second attribute information respectively comprise at least one identifier for identifying data.

In one aspect of the invention, the method further comprises deleting the first attribute information from the internal memory when the first memory is operationally disconnected from the mobile communication terminal.

In accordance with another embodiment of the present invention, a mobile terminal for managing information comprises an internal memory for storing information, a display for displaying information processed by the mobile terminal, and a control unit for controlling functions of the mobile terminal, wherein the control unit is adapted to detect whether a first memory is operationally connected to the mobile terminal, store first attribute information related to data stored in the first memory in the internal memory of the mobile terminal with second attribute information stored in the internal memory, wherein the second attribute information is related to data stored in the internal memory, and arrange the first attribute information and the second attribute information in the internal memory in a sequence according to a specific reference. Preferably, the first memory is an external memory.

In one aspect of the invention, the control unit generates compatible first attribute information for the data stored in the first memory if the first attribute information does not exist in the first memory. Moreover, the control unit formats the first attribute information to be compatible with the second attribute information if the first attribute information is not compatible with the second attribute information.

Preferably, the first attribute information and the second attribute information are stored and arranged in a specific area of the internal memory. Preferably, the specific area is a heap memory. Preferably, the display displays the first attribute information and second attribute information according to the arranged sequence.

In another aspect of the invention, the control unit designates at least one of the first attribute information in the internal memory for accessing data in the first memory related to the at least one of the first attribute information, and accesses the data in the first memory related to the at least one of the first attribute information designated in the internal memory.

Preferably, the first and second attribute information respectively comprise at least one of a name of data, a type of data, a generation time of data, a size of data, a copyright proprietor of data, a generating device of data, a position and contents of data, media rights conditions of data, media use conditions of data, and media use history of data. Preferably, the first and second attribute information comprise at least one identifier for identifying data.

In a further aspect of the invention, the control unit deletes the first attribute information from the internal memory when the first memory is disconnected from the mobile terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram illustrating an arranged memory structure when inserting an external memory into a terminal according to a related art.

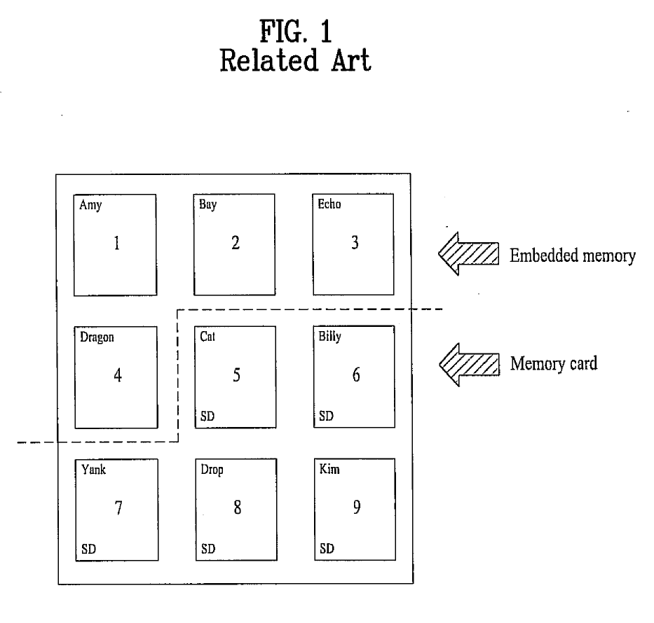

FIG. 2 is a block diagram of an apparatus for managing the storage of information in accordance with one embodiment of the present invention.

FIG. 3 is a flowchart for managing information in a mobile communication terminal in accordance with one embodiment of the present invention.

FIG. 4 is a diagram illustrating an arranged memory structure when inserting an external memory into a terminal in accordance with one embodiment of the present invention.

### DETAILED DESCRIPTION OF THE PREFERRED EMBODIMENTS

The present invention is related to managing information in a mobile communication terminal. Reference will now be made in detail to the preferred embodiments of the present invention, examples of which are illustrated in the accompanying drawings. Wherever possible, the same reference numbers will be used throughout the drawings to refer to the same or like parts.

An apparatus for managing storage of information according to the present invention is preferably adopted by a terminal, and more particularly, by a mobile communication terminal provided with an external memory. Moreover, the present invention is applicable to a terminal accommodating an external memory, such as a digital camera, a PDA (personal digital assistant), a digital music player (MP3 player) and the like. Preferably, a terminal which employs an apparatus for managing the storage of information according to the present invention is configured to enable an external memory to be loaded into and unloaded from a terminal body.

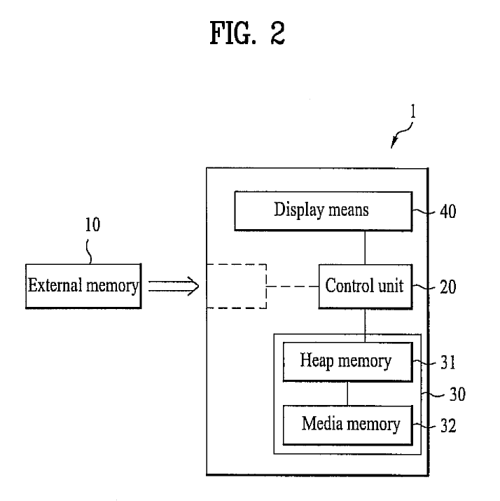

FIG. 2 is a block diagram of an apparatus for managing the storage of information in accordance with one embodiment of the present invention. Referring to FIG. 2, an apparatus for managing the storage of information according to the present invention includes a body 1 and an external memory 10 for loading into and unloaded from the body 1.

The body 1 includes a control unit 20, an embedded memory 30 and a display means 40. The external memory 10 stores at least one or more files therein. Preferably, the at least one or more files include media such as video, music and the like. Moreover, the external memory 10 is inserted in the body 1 to be loaded therein.

Preferably, the external memory 10 not only stores a file, but also metadata of the file. The metadata may include attribute information of a storage file, which is useful when representing or searching for the storage file.

The embedded memory 30 of the body 1 stores at least one file and metadata of the file. Preferably, the embedded memory 30 includes a heap memory 31 and a media memory 32. The heap memory 31 stores a plurality of metadata therein. The media memory 32 stores a plurality of files associated with the plurality of metadata stored in the heap memory 31, respectively. Preferably, the files stored in the media memory 32 correspond to media such as video, music and the like.

If it is detected that the external memory 10 is loaded into the body 1, the control unit 20 stores metadata of the external memory 10 in the heap memory 31 of the embedded memory 30. In this case, the metadata of the external memory 10 was either previously stored in the external memory 10 or is newly generated. Accordingly, the metadata of the external memory 10 and metadata associated with the files of the media memory 32 are stored in the heap memory 31 together.

Subsequently, the control unit 20 arranges or sorts a plurality of the metadata stored in the heap memory 31 in a sequence according to a specific reference. Preferably, the plurality of the metadata stored in the heap memory 31 correspond to a total of the metadata of the external memory 10 and a plurality of the metadata associated with the files of the media memory 32. Preferably, the metadata includes attribute information of the files associated with the corresponding metadata.

Preferably, when storing the metadata of the external memory 10 in the heap memory 31, the control unit 20 checks for a presence or non-presence of compatibility between the metadata of the external memory 10 and the metadata previously stored in the heap memory 31. If compatibility exists between the two kinds of metadata, the control unit 20 stores the metadata of the external memory 10 in the heap memory 31. If no compatibility exists between the two kinds of metadata, the control unit 20 generates metadata for the external memory 10 compatible with the metadata previously stored in the heap memory 31 and stores the generated metadata in the heap memory 31.

The above description refers to when the metadata associated with the file is already stored in the external memory 10. However, if the metadata associated with the file is not already stored in the external memory 10, the control unit 20 generates metadata comprising attribute information of a file with reference to the file stored in the external memory 10. In this case, the generated metadata is generated to be compatible with the metadata stored in the heap memory 31. Accordingly, the generated metadata is then stored in the heap memory 31.

If it is detected that the external memory 10 is loaded into the body 1, the control unit 20 allocates storage areas of the heap memory 31 to correspond to the number of files stored in the external memory 10 prior to storing the metadata of the external memory 10 in the heap memory 31. The control unit 20 then stores the metadata of the external memory 10 in the allocated storage areas. From the viewpoint of the body 1, the external memory 10 is a new memory and the metadata of the external memory 10 is new metadata.

In brief, the control unit 20 detects a new memory storing at least one or more files and configures at least one or more new metadata including attribute information of the at least one or more files stored in the new memory. The control unit 20 then stores the new metadata in at least one or more corresponding areas of the heap memory 31 allocated to correspond to the number of the at least one or more files of the new memory, respectively.

Subsequently, the control unit 20 arranges a plurality of the metadata (i.e., old metadata and new metadata) stored in the heap memory 31 in a sequence according to a specific reference. The display means 40 displays the plurality of the arranged metadata.

In particular, the display means 40 displays a plurality of the metadata (i.e., old metadata and new metadata) stored in the heap memory 31 in the arranged sequence. Substantially, the control unit 20 collects attributes of the files stored in the media memory 32 and displays the collected attributes in a predetermined sequence arrangement. It is a matter of course that the description for displaying the plurality of arranged metadata can be regarded as well as the description for displaying the attributes of stored files in the sequence arrangement. Therefore, in the following description, the plurality of metadata are arranged and the attributes of stored files are displayed in the arranged sequence.

An attribute includes at least one of a name, type, generation time, copyright proprietor and generating device (if an identifier is given to identify the corresponding device) of a stored file. Therefore, the control unit 20 may arrange attributes of stored files in a sequence according to at least one of the above elements corresponding to the attributes of the stored files.

For example, the control unit 20 may use a name of a stored file as a reference and arrange various names of stored files in an alphabetical sequence or other type of ordering sequence, such as one using Korean consonants and vowels. In another example, the control unit 20 may use a size of the stored file as a reference and arrange the stored files in order of an increasing or decreasing size.

Meanwhile, if one of the displayed attributes is designated, the control unit 20 accesses a corresponding stored file via metadata of the designated attribute. Preferably, the control unit 20 reads the corresponding stored file at a memory address indicated by the metadata of the designated attribute. This access process is explained in detail as follows.

First, if one of the displayed attributes is designated after the sequence arrangement, the control unit 20 activates a program to execute a corresponding stored file. The control unit 20 then pages the stored file using the executing program via the metadata indicating the designated attribute. In this case, if the stored file is video media, then paging the stored file results in playing back the video media using the executing program.

Once the external memory 10 is unloaded from the body 1, the control unit 20 detects that the external memory 10 has been unloaded. The control unit 20 then deletes the metadata of the external memory 10 from the heap memory 31.

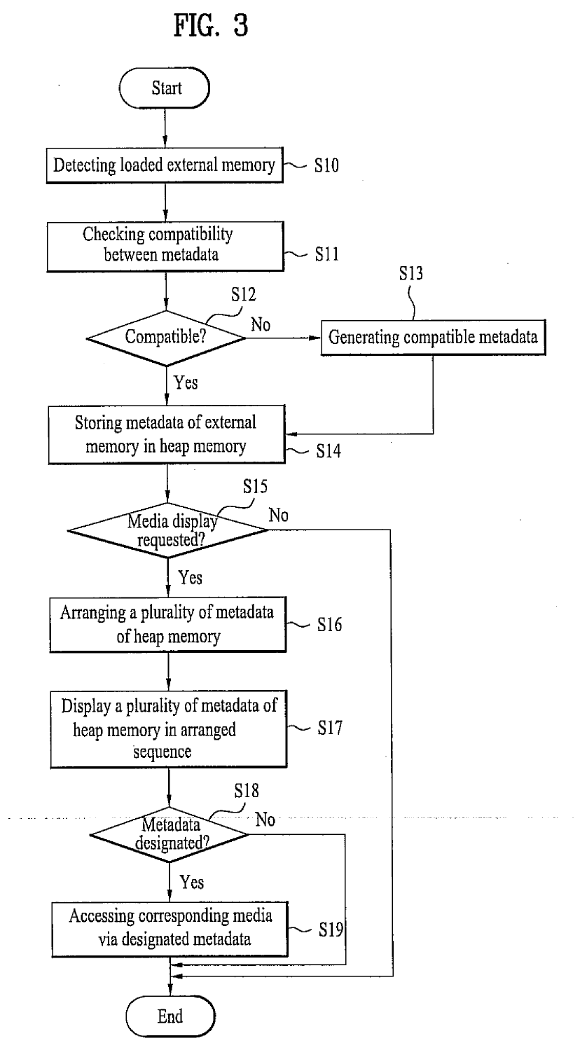

FIG. 3 is a flowchart for managing information in a mobile communication terminal in accordance with one embodiment of the present invention. Here, an external memory is loaded in a terminal body and media stored in the external memory or an embedded memory is video media, for example. Furthermore, video data and metadata associated with the video media are stored in the external memory, for example.

Referring to FIG. 3, a control unit of a terminal detects whether an external memory is loaded (S10). Preferably, the external memory stores at least one or more video media and metadata associated with the at least one or more video media therein.

As the newly loaded external memory is detected, the control unit checks whether the metadata stored in the external memory is compatible with metadata stored in an embedded memory, and more particularly, in a heap memory (S11). If the metadata stored in the external memory is compatible with the metadata stored in the heap memory (S12), the control unit stores the corresponding metadata of the external memory in an allocated area of the heap memory (S14).

However, if the metadata stored in the external memory is not compatible with the metadata stored in the heap memory (S12), the control unit generates metadata compatible with the metadata stored in the heap memory for use by the external memory (S13). The control unit then stores the generated metadata in the allocated area of the heap memory (S14).

Preferably, the allocated area of the heap memory is a storage area of the heap memory allocated to correspond to the number of video media stored in the external memory. Preferably, the allocation is facilitated by the control unit when detecting the loaded external memory.

When detecting a new memory, such as the loaded external memory, the control unit checks the compatibility of the metadata stored in the detected memory and stores the compatible new metadata in the heap memory. Subsequently, the control unit combines all metadata (new metadata of the external memory and previously-stored metadata of the embedded memory) stored in the heap memory together and arranges them (S16). Preferably, the arrangement, as shown in FIG. 3, is carried out when there is a display request for video media (S15). However, in accordance with the present invention, execution of the arrangement operation is not only limited to when the display request for video media is made.

After all metadata stored in the heap memory are arranged, a plurality of the metadata are displayed according to their arranged sequence (S17). Accordingly, because the metadata include attributes of video media, the attributes of the video media stored in the external memory and the attributes of the video media stored in the embedded memory are displayed as arranged.

Meanwhile, the arranged sequence of the metadata may be decided by an identifier of the corresponding video media. Therefore, an attribute of the video media is at least one identifier for identifying the corresponding video media. Moreover, the identifier is at least one of a name, type, generation time, size, copyright proprietor and generating device of the corresponding video media. Optionally, attributes of the video media may include a position and contents of the video media, video media right conditions, video media use conditions, video media use history, and the like.

If metadata of a specific video media is designated among a plurality of the displayed metadata after the above arrangement is made (S18), the control unit accesses the corresponding video media via the designated metadata (S19) according to the access process explained in the above description.

If the external memory is unloaded from the body, the control unit detects the unloading. Accordingly, the control unit deletes the external memory metadata stored in the heap memory immediately or after a duration of time. The control unit then rearranges the rest of the metadata, i.e., the metadata originally stored in the heap memory, in a sequence according to a predetermined reference.

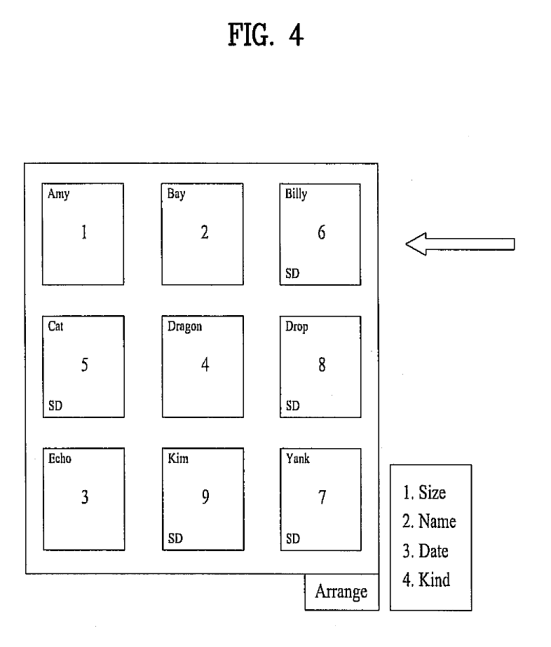

FIG. 4 is a diagram illustrating an arranged memory structure when inserting an external memory into a terminal in accordance with one embodiment of the present invention. Preferably, a plurality of media are arranged by newly configuring a plurality of metadata when loading (inserting) the external memory.

Referring to FIG. 4, if an external memory, i.e., a memory card is loaded (inserted) while attributes (e.g., names) of a plurality of media stored in an embedded memory are arranged in an alphabetical order, metadata of the memory card and metadata of the embedded memory are combined together to be arranged according to one reference.

Therefore, attribute information of a plurality of media stored in the memory card and attribute information of the plurality of media stored in the embedded memory are combined with each other and arranged according to the same reference. For example, in FIG. 4, reference numbers 1, 2, 3 and 4 correspond to media stored in the embedded memory, respectively. Meanwhile, reference numbers 5, 6, 7, 8 and 9 correspond to media stored in the memory card, respectively. In the present invention, a plurality of the media are arranged according to one reference. Preferably, media names are arranged in an alphabetical order, as shown in FIG. 4.

Specifically, in the present invention, a reference for arranging media can be changed even if the media are already previously arranged. For example, after the media have been arranged according to media names by alphabetical order, the reference for arranging the media can be changed to a media size, a media generating date, a media type or other attribute. Preferably, the reference for arranging media of the present invention includes a reference applicable to all general cases of arranging a plurality of files within a random directory.

Accordingly, the present invention provides the following advantages. First, because information (file or media) stored in an external memory is managed as metadata via a heap memory, a process for managing information need not directly access the external memory loaded (inserted) into a terminal. Hence, a time (latency) required for accessing the information stored in the external memory is minimized.

Second, in loading an external memory, because information stored in the external memory is managed, via the heap memory having a flexible allocation, and together with information stored in an embedded memory, management performance of the stored information is enhanced. Furthermore, a memory capacity for supporting the storage of information is flexible as well.

Third, because information is arranged in a sequence according to one reference by combining an attribute of information stored in an external memory and an attribute of information stored in an embedded memory, efficient management of the stored information is facilitated.

Fourth, because metadata is newly configured each time an external memory is loaded, stored information can be managed with the metadata even if the loaded external memory is replaced with a different external memory.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for managing information in a mobile communication terminal, the method comprising:
detecting whether a first memory is operationally connected to the mobile communication terminal;
storing first attribute information related to data stored in the first memory in an internal memory of the mobile communication terminal with second attribute information stored in the internal memory, wherein the second attribute information is related to data stored in the internal memory; and
arranging the first attribute information and the second attribute information in the internal memory in a sequence according to a specific reference.

2. The method of claim 1, wherein the first memory is an external memory.

3. The method of claim 1, further comprising generating compatible first attribute information for the data stored in the first memory if the first attribute information does not exist in the first memory.

4. The method of claim 1, further comprising formatting the first attribute information to be compatible with the second attribute information if the first attribute information is not compatible with the second attribute information.

5. The method of claim 1, wherein the first attribute information and the second attribute information are stored and arranged in a specific area of the internal memory.

6. The method of claim 5, wherein the specific area is a heap memory.

7. The method of claim 1, further comprising displaying the first attribute information and second attribute information according to the arranged sequence.

8. The method of claim 1, further comprising:
designating at least one of the first attribute information in the internal memory for accessing the data in the first memory related to the at least one of the first attribute information; and
accessing the data in the first memory related to the at least one of the first attribute information designated in the internal memory.

9. The method of claim 1, wherein the first and second attribute information respectively comprise at least one of:
a name of data;
a type of data;
a generation time of data;
a size of data;
a copyright proprietor of data;
a generating device of data;
a position and contents of data;
media rights conditions of data;
media use conditions of data; and
media use history of data.

10. The method of claim 1, wherein the first and second attribute information respectively comprise at least one identifier for identifying data.

11. The method of claim 1, further comprising deleting the first attribute information from the internal memory when the first memory is operationally disconnected from the mobile communication terminal.

12. A mobile terminal for managing information, the mobile terminal comprising:
an internal memory for storing information;
a display for displaying information processed by the mobile terminal; and
a control unit for controlling functions of the mobile terminal, wherein the control unit is adapted to:
detect whether a first memory is operationally connected to the mobile terminal;
store first attribute information related to data stored in the first memory in the internal memory of the mobile terminal with second attribute information stored in the internal memory, wherein the second attribute information is related to data stored in the internal memory; and
arrange the first attribute information and the second attribute information in the internal memory in a sequence according to a specific reference.

13. The mobile terminal of claim 12, wherein the first memory is an external memory.

14. The mobile terminal of claim 12, wherein the control unit generates compatible first attribute information for the data stored in the first memory if the first attribute information does not exist in the first memory.

15. The mobile terminal of claim 12, wherein the control unit formats the first attribute information to be compatible with the second attribute information if the first attribute information is not compatible with the second attribute information.

16. The mobile terminal of claim 12, wherein the first attribute information and the second attribute information are stored and arranged in a specific area of the internal memory.

17. The mobile terminal of claim 16, wherein the specific area is a heap memory.

18. The mobile terminal of claim 12, wherein the display displays the first attribute information and second attribute information according to the arranged sequence.

19. The mobile terminal of claim 12, wherein the control unit:
designates at least one of the first attribute information in the internal memory for accessing data in the first memory related to the at least one of the first attribute information; and
accesses the data in the first memory related to the at least one of the first attribute information designated in the internal memory.

20. The mobile terminal of claim 12, wherein the first and second attribute information respectively comprise at least one of:
a name of data;
a type of data;
a generation time of data;
a size of data;
a copyright proprietor of data;
a generating device of data;
a position and contents of data;
media rights conditions of data;
media use conditions of data; and
media use history of data.

21. The mobile terminal of claim 12, wherein the first and second attribute information respectively comprise at least one identifier for identifying data.

22. The mobile terminal of claim 12, wherein the control unit deletes the first attribute information from the internal memory when the first memory is disconnected from the mobile terminal.
